(19) United States
(12) Patent Application Publication
(10) Pub. No.: US 2026/0362319 A1
(43) Pub. Date: Nov. 12, 2026

(54) AUTOMATIC POWER SAVE DELIVERY (APSD) QUALITY-OF-SERVICE (QOS) NULL FRAME FOR POWER SAVING IN A PRIVACY CONTEXT

(71) Applicant: Cisco Technology, Inc., San Jose, CA (US)

(72) Inventors: Javier Contreras, Barcelona (ES); Domenico Ficara, Essertines-sur-Yverdon (CH); Federico Lovison, Fontanelle (IT); Ugo Mario Campiglio, Morges (CH); Jerome Henry, Pittsboro, NC (US)

(21) Appl. No.: 19/671,942

(22) Filed: May 8, 2026

Related U.S. Application Data
(60) Provisional application No. 63/803,258, filed on May 9, 2025.

(51) Int. Cl. H04W 52/02; H04W 28/06; H04W 80/02

(52) U.S. Cl. CPC H04W 52/0206; H04W 28/06; H04W 80/02

(57) ABSTRACT

An Automatic Power Save Delivery (APSD) Quality-of-Service (QoS) null frame for power saving in a privacy context may be provided. An Access Point (AP) may receive a frame during a predetermined transition period. The predetermined transition period is at a beginning of a second epoch that follows a first epoch. A first Media Access Control (MAC) address is associated with the client device for the first epoch and a second MAC address is associated with the client device for the second epoch. Next the AP may determine a frame MAC address associated with the frame. Then the AP may ignore the frame received during the predetermined transition period when the frame MAC address comprises the first MAC address.

### RELATED APPLICATION

Under provisions of 35 U.S.C. § 119(e), Applicant claims the benefit of U.S. Provisional Application No. 63/803,258, filed May 9, 2025, which is incorporated herein by reference.

### TECHNICAL FIELD

The present disclosure relates generally to providing an Automatic Power Save Delivery (APSD) Quality-of-Service (QoS) null frame for power saving in a privacy context.

### Background

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing an Automatic Power Save Delivery (APSD) Quality-of-Service (QoS) null frame for power saving in a privacy context;

FIG. 2 is a flow chart of a method for providing an APSD QoS null frame for power saving in a privacy context; and

FIG. 3 is a block diagram of a computing device.

### DETAILED DESCRIPTION

### Overview

An Automatic Power Save Delivery (APSD) Quality-of-Service (QoS) null frame for power saving in a privacy context may be provided. An Access Point (AP) may receive a frame during a predetermined transition period. The predetermined transition period is at a beginning of a second epoch that follows a first epoch. A first Media Access Control (MAC) address is associated with the client device for the first epoch and a second MAC address is associated with the client device for the second epoch. Next the AP may determine a frame MAC address associated with the frame. Then the AP may ignore the frame received during the predetermined transition period when the frame MAC address comprises the first MAC address.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

As part of the Institute of Electrical and Electronics Engineers (IEEE) 802.11bi privacy extensions standard, an objective may be to make it difficult for eavesdroppers to track individual client devices (e.g., Stations (STAs)) over time. This may be done through the obfuscation of different parameters and fields in the IEEE 802.11 header and the rotation of Media Access Control (MAC) addresses. The obfuscation and MAC addresses are changed (e.g., transitioned) every “epoch” on a negotiated time interval, and the objective is that it should not be possible carry over the identification of a client device in epoch N into a next epoch N+1.

The aforementioned epoch transition may represent a problem for some power saving mechanisms. IEEE 802.11 Automatic Power Save Delivery (APSD) defines a process where client devices may signal when they are going to sleep (thus saving power), with the Unscheduled-APSD (U-APSD) as a common implementation across many scenarios. In U-APSD, any data frame may be used to signal when the client device will wake up and remain active, or when it will go to sleep, by setting a Power Management flag in a frame control field. For IEEE 802.11ax, this may be done commonly through QoS null data frames. When an AP receives a data frame with the power management flag set, it may buffer frames with a destination to the client device, until a new frame is received with the bit unset.

Given that null data frames are not protected, it may be possible for a eavesdropper to monitor for client devices that go to sleep on epoch N, then wait until epoch N+1 goes in place, and send a spoofed null frame with the bit unset, shortly after the epoch change. As the IEEE 802.11bi standard defines that there is a short transition period where old MAC addresses are still accepted as Receive (RX), but any Transmission (TX) after the transition period will use the new addresses. This will trigger the AP to transmit any buffered frames to the new MAC address. Accordingly, the spoofed null data could be used as a mechanism to “bridge” client device addresses across epochs, if the U-APSD mechanism is in use. In other words, the AP would send the buffered traffic for the victim to the MAC address of the victim of epoch N+1, thus the spoofer may then learn the new MAC address of the victim and connects the MAC address of epoch N to the MAC address of epoch N+1.

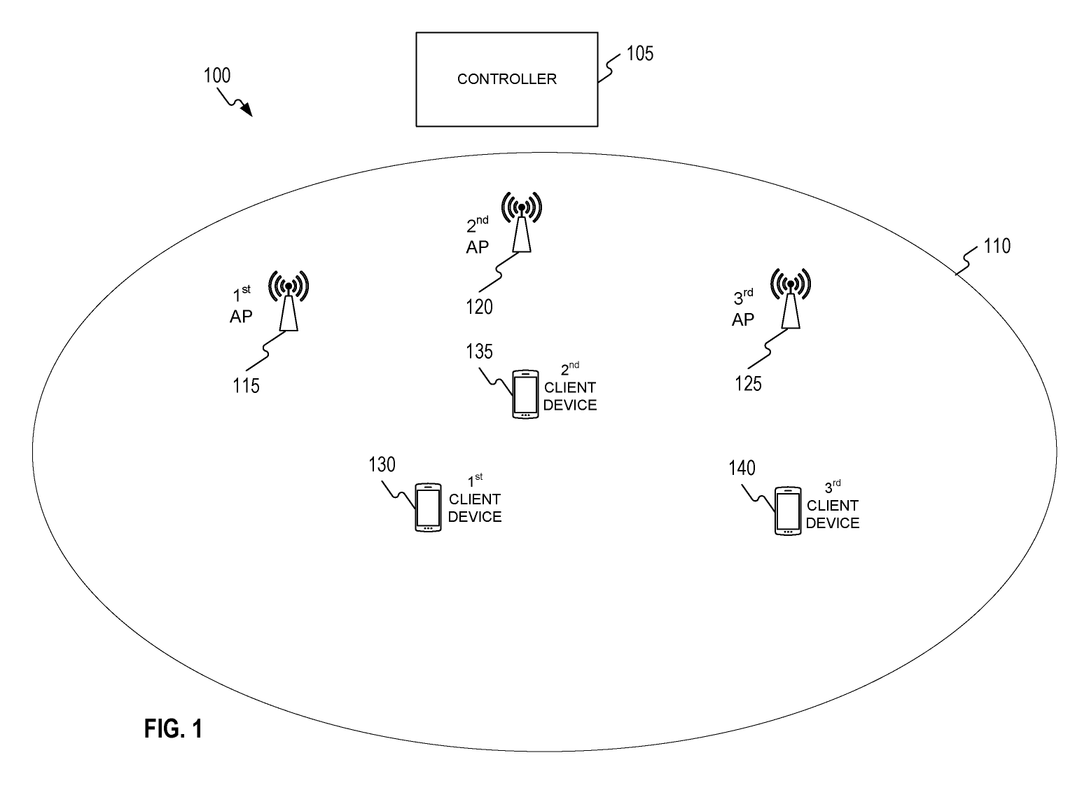

FIG. 1 shows an operating environment 100 for providing an Automatic Power Save Delivery (APSD) Quality-of-Service (QoS) null frame for power saving in a privacy context. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide an APSD QoS null frame for power saving in a privacy context.

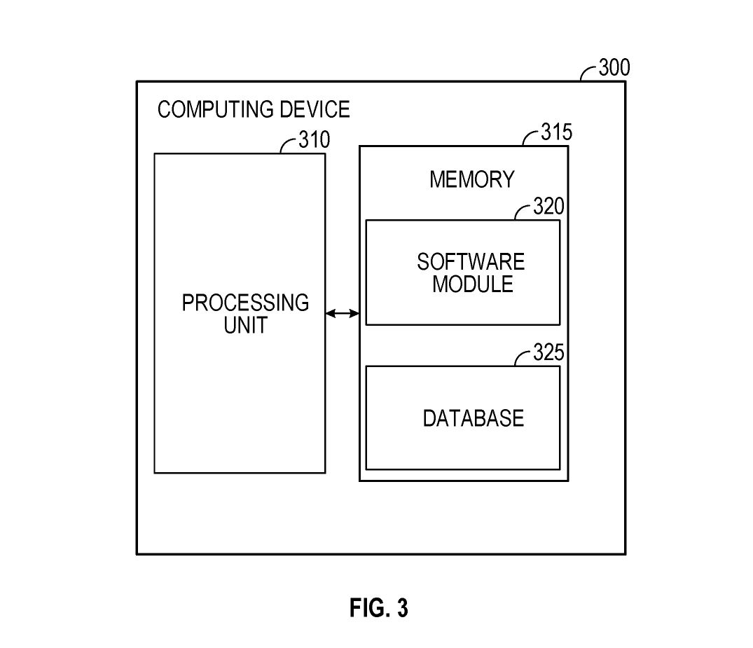

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

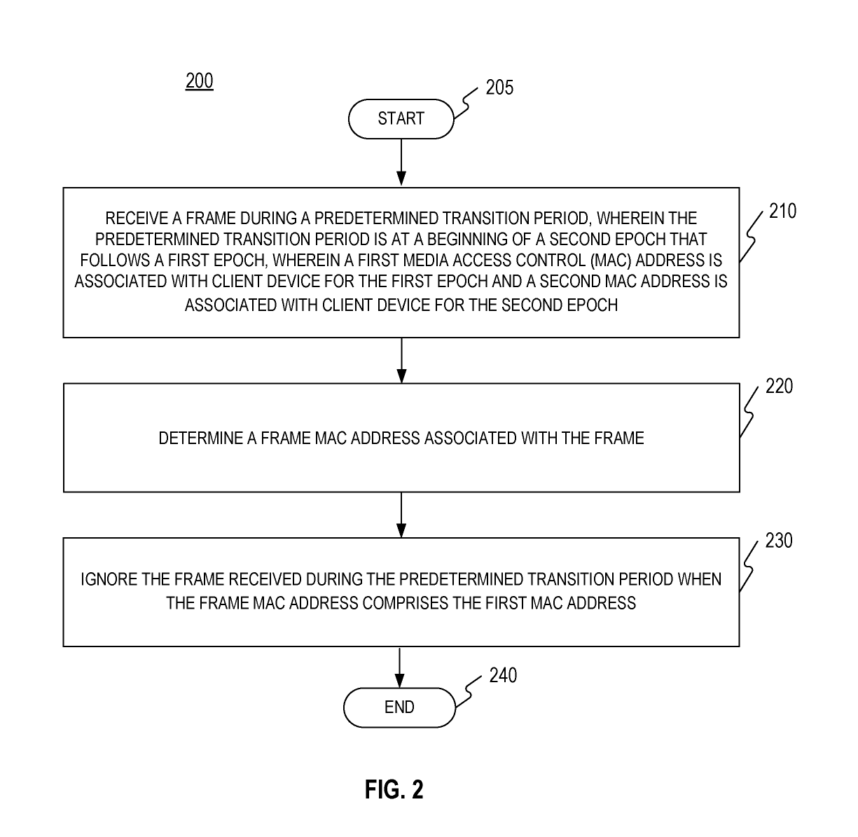

FIG. 2 is a flow chart setting forth the general stages involved in a method 200 consistent with embodiments of the disclosure for providing an APSD QoS null frame for power saving in a privacy context. Method 200 may be implemented using first AP 115 that may be embodied by computing device 300 as described in more detail below with respect to FIG. 3. Ways to implement the stages of method 200 will be described in greater detail below.

Method 200 may begin at starting block 205 and proceed to stage 210 where first AP 115 may receive a frame during a predetermined transition period. The predetermined transition period may be at a beginning of a second epoch that follows a first epoch. A first Media Access Control (MAC) address may be associated with first client device 130 for the first epoch and a second MAC address may be associated with first client device 130 for the second epoch. For example, for U-APSD, any client device transmitting a Data/QoS Data null frame as a trigger should transmit with the new mac address (and the rest of the Frame Anonymization (FA) parameters) of the corresponding epoch consistent with embodiments of the disclosure.

In other words, first client device 130 may send the frame. During the first epoch, the first MAC address may be valid for first client device 130 and during the second epoch, the second MAC address may be valid for first client device 130. An epoch duration may be between 1 second and 18 hours. The predetermined transition period may be defined in 10 millisecond units (minimum time) and may be 11 bits longs so it may be up to 20 seconds for example. The predetermined transition period duration may be determined by the AP together with the epoch duration. Its purpose may be for client devices to empty transmission queues buffers (i.e., transmitting all frames that already have been formatted with the previous epoch parameters, but had not a chance to be transmitted yet before the epoch transition). FA parameters are the per-epoch parameters used by both an AP and a client device when the feature is activated. These may include, but are not limited to, an Access Identifier (AID), and a MAC Header Anonymization (MHA) block. The MHA block may determines how the MAC address, the packet number, the sequence number should be rotated/calculated in each epoch.

From stage 210, where first AP 115 receives the frame during the predetermined transition period, method 200 may advance to stage 220 where first AP 115 may determine a frame MAC address associated with the frame. For example, first AP 115 may parse the frame to determine the MAC address associated with the frame (i.e., frame MAC address). First AP 115 may use the frame MAC address to determine how to handle the frame.

Once first AP 115 determines the frame MAC address associated with the frame in stage 220, method 200 may continue to stage 230 where first AP 115 may ignore the frame received during the predetermined transition period when the frame MAC address comprises the first MAC address. For example, first AP 115 may ignore any frames if they come with the old MAC address (i.e., the first MAC address), even during the predetermined transition period. In other words, embodiments of the disclosure may put an additional restriction that the epoch predetermined transition period may only accept protected data frames, and should silently drop non-protected frames.

The ignored frame may have come from a spoofer. The spoofer may only know the victim MAC address (i.e., first MAC address) of the epoch (i.e., first epoch) in which the victim (e.g., first client device 130) is going to sleep (the victim signals it enters sleep). The spoofer may know that, in conventional systems, during the predetermined transition time in the second epoch, first AP 115 may still accept frames coming from the victim using the previous epoch MAC (first MAC address for the first epoch). If the spoofer knows when the epoch transition happens, it may send the spoofed null frame in the new epoch (i.e., second epoch) during the predetermined transition period using the victim MAC address (first MAC address) of the first epoch. With conventional system, first AP 115 would then send the buffered traffic for the victim to the MAC address of the victim of second epoch. Therefore, with conventional systems the spoofer may then learn the new MAC address (i.e., the second MAC address) of the victim and then connect the MAC address of the first epoch to the MAC address of the second epoch. Embodiments of the disclosure may address this short coming of conventional systems by ignoring any frames if they come with the old MAC address (i.e., the first MAC address), even during the predetermined transition period. Once first AP 115 ignores the frame received during the predetermined transition period when the frame MAC address comprises the first MAC address in stage 230, method 200 may then end at stage 240.

In other embodiments of the disclosure, U-APSD trigger frames may be modified, and a new type of Data/QoS Data null frames may be sent protected. With conventional systems, the QoS null is represented by type 10 (binary) and Subtype (1100). The subtype 1101 is reserved, and may be used to send a new protected QoS null frame, with random padding payload encrypted, that must be discarded. In another embodiment, null frames may be extended with some random discardable data for protection to be applied. In another variation, a protected action frame may be introduced for such scenario. In yet another variation, an Information Element (IE) in protected action frames may carry the same meaning (e.g., “I woke up, please share buffered data”) for example.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing an APSD QoS null frame for power saving in a privacy context as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by an Access Point (AP), a frame during a predetermined transition period, wherein the predetermined transition period is at a beginning of a second epoch that follows a first epoch, wherein a first Media Access Control (MAC) address is associated with a client device for the first epoch and a second MAC address is associated with the client device for the second epoch;
determining a frame MAC address associated with the frame; and
ignoring the frame received during the predetermined transition period when the frame MAC address comprises the first MAC address.

2. The method of claim 1, further comprising accepting the frame received during the predetermined transition period when the frame MAC address comprises the second MAC address.

3. The method of claim 1, wherein the frame comprises a null frame.

4. The method of claim 1, wherein the frame comprises a Unscheduled-Automatic Power Save Delivery (U-APSD) frame.

5. The method of claim 1, wherein the frame comprises Frame Anonymization (FA) parameters.

6. The method of claim 5, wherein the FA parameters comprises an Association Identifier (AID) and a MAC Header Anonymization (MHA) block.

7. The method of claim 1, wherein the predetermined transition period is between 10 millisecond and 20 seconds long.

8. The method of claim 1, wherein the first epoch is between 1 second and 18 hours long.

9. The method of claim 1, wherein the second epoch is between 1 second and 18 hours long.

10. A system comprising:
a memory storage; and
a processing unit disposed in an Access Point (AP) and coupled to the memory storage, wherein the processing unit is operative to:
receive a frame during a predetermined transition period, wherein the predetermined transition period is at a beginning of a second epoch that follows a first epoch, wherein a first Media Access Control (MAC) address is associated with a client device for the first epoch and a second MAC address is associated with the client device for the second epoch;
determine a frame MAC address associated with the frame; and
ignore the frame received during the predetermined transition period when the frame MAC address comprises the first MAC address.

11. The system of claim 10, wherein the processing unit is further operative to accept the frame received during the predetermined transition period when the frame MAC address comprises the second MAC address.

12. The system of claim 10, wherein the frame comprises a null frame.

13. The system of claim 10, wherein the frame comprises a Unscheduled-Automatic Power Save Delivery (U-APSD) frame.

14. The system of claim 10, wherein the frame comprises Frame Anonymization (FA) parameters.

15. A non-transitory computer-readable medium that stores a set of instructions which when executed perform a method executed by the set of instructions comprising:
receiving, by an Access Point (AP), a frame during a predetermined transition period, wherein the predetermined transition period is at a beginning of a second epoch that follows a first epoch, wherein a first Media Access Control (MAC) address is associated with a client device for the first epoch and a second MAC address is associated with the client device for the second epoch;
determining a frame MAC address associated with the frame; and
ignoring the frame received during the predetermined transition period when the frame MAC address comprises the first MAC address.

16. The non-transitory computer-readable medium of claim 15, further comprising accepting the frame received during the predetermined transition period when the frame MAC address comprises the second MAC address.

17. The non-transitory computer-readable medium of claim 15, wherein the frame comprises a null frame.

18. The non-transitory computer-readable medium of claim 15, wherein the frame comprises a Unscheduled-Automatic Power Save Delivery (U-APSD) frame.

19. The non-transitory computer-readable medium of claim 15, wherein the frame comprises Frame Anonymization (FA) parameters.

20. The non-transitory computer-readable medium of claim 19, wherein the FA parameters comprises an Association Identifier (AID) and a MAC Header Anonymization (MHA) block.
